(19) United States
(12) Patent Application Publication
(10) Pub. No.: US 2004/0138066 A1
(43) Pub. Date: Jul. 15, 2004

(54) Triaxial hts cable

(76) Inventors: Uday K Sinha, Carrollton, GA (US); R L Hughey, Franklin, GA (US)

Correspondence Address: Smith Gambrell & Russell, Promenade II, Suite 3100, 1230 Peachtree Street NE, Atlanta, GA, 30309-3592, US

(21) Appl. No.: 10/479,768

(22) PCT Filed: Jul. 30, 2002
(86) PCT No.: PCT/US02/24244

(30) Foreign Application Priority Data
Aug. 1, 2001 (US) 60309426

(51) Int. Cl. B32B 1/00

(52) U.S. Cl. 505/231

(57) ABSTRACT

A High-Temperature Superconducting (HTS) transmission cable based on the cold dielectric concept with an HTS shield makes it possible to house all three phases inside a single cryostat without causing large degradation and loss due to magnetic fields generated by the neighboring phases. A further optimization is realized by making the three phases concentric to each other. No shielding layer is required in such a tri-axial configuration. It is more compact and requires only about half of the HTS tapes as that of three separately shielded phases. Each phase advantageously consists of two layers of BSCCO-2223 HTS tapes.

### CROSS-REFERENCE TO RELATED APPLICATION

The present application claims priority to provisional application Serial No. 60/309,426, filed Aug. 1, 2001, which is relied on and incorporated herein by reference.

### BACKGROUND OF THE INVENTION

1. Field of the Invention

The present invention relates to a superconducting cable for alternating current.

2. Description of the Background Art

Superconducting materials are those where the electric resistance approaches zero (1 uv/cm) below a critical temperature, its value depending on the material. Superconductivity is defined within a critical surface, i.e. a graph or figure with its axes being temperature, electrical current and magnetic field. Thus, for a given working temperature there is a defined curve of critical current which is a function of the magnetic field generated and/or applied to the superconductor.

The best known superconductor materials are NbTi and Nb₃Sn, however their working temperature is only 4.2K, the boiling temperature of liquid helium. This is the main limitation to large scale application of these superconducting materials. Such superconductors are therefore used almost exclusively for winding of magnets. Manufactured from wires (NbTi and Nb₃Sn) or tapes (Nb₃Sn) with high critical current densities (3500 A/mm² 5 Tesla for NbTi), such winding of compact magnets provide the production of high fields (up to 18 Tesla) in large volumes.

These superconductor magnets are used for the formation of medical images by nuclear magnetic resonance (MRI) and for materials analysis by the same principle (NMR), the magnets for ore separation and research magnets for high fields, such as those used in large particle accelerators (SSC, HERA, KEK, etc.).

Oxide superconductors of higher critical temperatures were discovered in 1986. These are intermetalic compounds involving metal oxides and rare earths, with perovskite (mica) crystal structure. Their critical temperatures vary from 30K to approaching room temperature and their critical fields are above 60 Tesla Therefore these materials are considered promising and may replace Nb₃Sn and NbTi in the manufacture of magnets and find other applications not feasible with liquid helium, such as transmission of electricity. Such materials have not previously been available as wires, cables, films, tapes or sheets. An oxide superconductor which enters the superconducting state at the temperature of liquid nitrogen would be advantageous for application in a superconducting cable having a cooling medium of liquid nitrogen. With such an application, it would be possible to simultaneously attain simplification of the thermal protection system and reduction of the cooling cost in relation to a superconducting cable which requires liquid helium.

A superconducting cable must be capable of transmitting high current with low energy loss in a compact conductor. Power transmission is generally made through an alternating current, and a superconductor employed under an alternating current would inevitably be accompanied by energy loss, generically called AC loss. AC losses such as hysteresis loss, coupling loss, or eddy current loss depends on the critical current density of the superconductor, size of filaments, the structure of the conductor, and the like.

Various types of superconducting cables have been experimentally produced using metallic superconductors to study the structures for reducing AC loss, such as a superconductor which comprises a normal conductor and composite multifilamentary superconductors which are spirally wound along the outer periphery of the normal conductor. The conductor is formed by clockwisely and counterclockwise wound layers of composite multifilamentary superconductors, which are alternately superimposed with each other. The directions for winding the conductors are varied every layer for reducing magnetic fields generated in the conductors, thereby reducing impedance and increasing current carrying capacity thereof This conductor has a high-resistance or insulating layer between the layers.

When a cable conductor is formed using an oxide superconductor, the technique employed in a metal superconductor cannot be used. An oxide superconductor, i.e., a ceramic superconductor, is fragile and weak in mechanical strain compared with a metal superconductor. For example, the prior art discloses a technique of spirally winding superconductors around a normal conductor so that the winding pitch is equal to the diameter of each superconductor. However, when a superconducting wire comprising an oxide superconductor covered with a silver sheath is wound at such a short pitch, there is a high probability that the oxide superconductor will be broken, thereby interrupting the current. When an oxide superconducting wire is extremely bent, its critical current may also be greatly reduced.

The cable conductor must be flexible to some extent to facilitate handling. It is also difficult to manufacture a flexible cable conductor from a hard, fragile oxide superconductor.

To an increasing degree, superconducting cable for ac yields potential low-loss transmission capability. There are known superconducting cables for this application, but the construction is complex and the manufacture of these cables is very expensive. This is essentially the reason that hinders the use of these cables. As with known superconducting cables, the phase conductors of the present invention are manufactured of superconducting material. This necessitates separate cooling for each phase. The space within the phase conductors is used as a channel for the cooling material whereby closed-loop liquid coolant is used.

### SUMMARY OF THE INVENTION

The present invention has the underlying object of providing a superconducting cable that is more compact, uses less, i.e. about one-half, material and whose cooling mechanism is smaller than the known cables of this art i.e. reduced cryostat losses when going from three cryostats to one.

The present superconducting cable is constructed so that for the three phase conductors (22, 23, 24) only a single neutral conductor is required. Additionally, the phase conductors, the neutral conductor, and the cooling channels are concentrically arranged around one another. In this construction, the superconducting cable achieves a very compact construction. The cooling of the cable is advantageously accomplished with liquid nitrogen. An electrical insulation is used between the phase conductors (22, 23, 24), as well as the neutral conductor. This is advantageously manufactured from polyethylene or polypropylene. The cable restricts outwards thermal loss by employing a vacuum-insulation. The coolant circulates out through the central core of the cable, and back in an annular channel that is directly connected to the vacuum-insulation.

### BRIEF DESCRIPTION OF THE DRAWINGS

FIG. 1 is a cross-section of a cable of the present invention.

FIG. 2 is a cross-section of a cable of the present invention along with a cross-section of a prior art single phase cable.

### DESCRIPTION OF THE PREFERRED EMBODIMENT

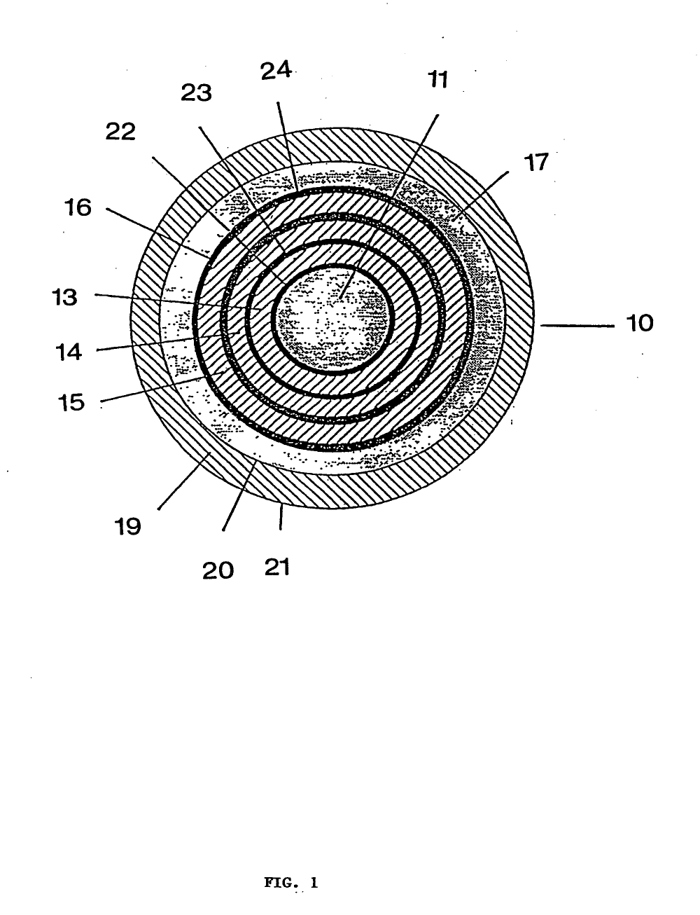

FIG. 1 illustrates a superconducting cable (10) in cross-section. The core of the cable is built around a former resulting in a channel (11) having a diameter of from about 25 to about 200 mm through which the coolant is conducted. Other diameters can be selected. In the present design, liquid nitrogen is utilized. The channel (11) defines the boundary of first phase conductor (22) and the conducting cable core. The phase conductor (22) is manufactured of superconducting tapes. The manufacture of the tapes features sleeves of silver filled with a ceramic material that utilizes a high temperature superconductor. Preferably the sleeves (not shown) are filled with a powdered superconductor material. Advantageously the superconductor material is selected from the group consisting of Bi-2223, Bi-2212 and YBCO coated conductor. Preferably the superconductor material is Bi-2223 or BSCCO. Subsequently the sleeves are rolled into surfaced tapes. These tapes are wrapped on a former whereupon the (22) conductor is manufactured. The thickness of the (22) conductor preferably is about 0.1 to about 10 mm. On the first phase conductor (22) an electrical insulation (13) is applied. This is advantageously made of polyethylene or polypropylene. For this purpose, the dielectric tapes are wound with this material until the insulation (13) reaches the desired thickness. In this embodiment, the thickness of the insulation preferably amounts to from about 10 to about 50 mm. Around insulation (13) is the second phase conductor (23). This is again manufactured with tapes of superconducting material. These are wound about the insulation (13). The phase conductor (23) achieves the same capacity as the phase conductor (22). Around the phase conductor (23) is a subsequent insulation (14). This is manufactured in the same manner and capacity as the insulation (13). Over the insulation (14) is placed the third phase conductor (24), which is manufactured in the same manner and capacity as the phase conductors (22) and (23). Over the phase conductor (24) is a further insulation (15) that is manufactured in the same manner as the insulations (13) and (14). However, the thickness of the insulation (15) may not need to be as great as the thickness of the insulations (13) and (14). In some cases it may be 60% or less. Outwards of the insulation (15) is the boundary of the neutral conductor (16). This neutral conductor (16) has, under symmetric load, only a small current to carry, and can therefore be manufactured of customary conducting material, preferably copper. The thickness in this embodiment amounts to a few mm. The return conductor also serves as a border for the closed-ring cooling channel (17) through which the circulating liquid nitrogen is conducted. The diameter of the cooling channel (17) preferably amounts to from about 150 to about 500 mm. Outwards from the cooling channel (17) is a vacuum-super-insulation (19). In an alternate embodiment there is an armor layer between (20) and (24) with nitrogen flowing only in one deviation on the outside of the armor layer. This defines an inner boundary surface (20) and an outer boundary surface (21). Between both boundary surfaces an annular space is provided, which is evacuated and filled with the super insulation. The insulation material advantageously is evaporated aluminum plastic film.

The present invention's design provides several advantages: minimizing the size and the heat input, insuring the initial and return paths for the cooling medium, minimizing the volume and cost of the superconductor and its ac loss, insuring the dielectric, safety in normal and fault conditions and avoiding any thermal or mechanical degradation. The present invention is thus represented by a tubular co-axial distribution of three phases (see FIG. 1).

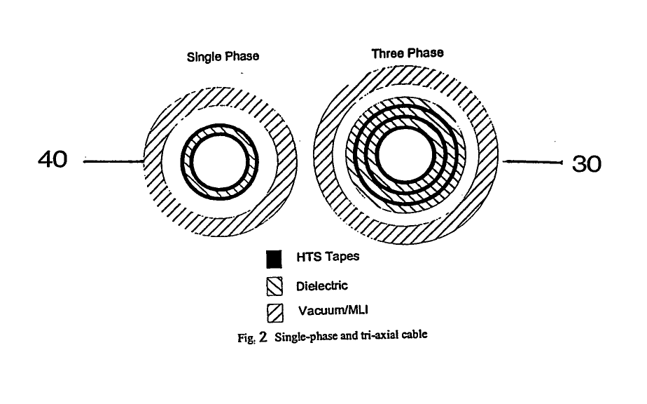

FIG. 2 is a cable cross-section indicating the relative size of a single phase (40) and a tri-axial cable (30).

Details on semi-conducting tapes, bedding tapes, protective wrapping tapes, etc. are omitted. The liquid nitrogen flow cross-sectional areas are about the same but the dielectric is somewhat thicker for the tri-axial cable due to the higher phase-to-phase voltage between the HTS conductors relative to the phase-to-ground voltage in a co-axial, single-phase cable.

In a standard prior art structure, three phase conductors are separated in order to avoid excessive fringe fields and eddy currents, each phase conductor is covered by a co-axial shielding conductor able to return the full current. In the present inventive cable design, there is no need of shielding conductors; the superconductor quantity and cost is significantly reduced just as are the corresponding ac losses.

The selected cryogen advantageously is liquid nitrogen. It also provides the dielectric insulation between the different phases (or tapes or tubes), without risk of gas bubbles generation.

Liquid nitrogen flows upstream inside an inner pipe and downstream inside the gaps between the superconducting phases.

The object is to subdivide and interlink the phase conductors, in order to minimize the magnetic field applied to the conductors.

The phases are connected in series by several flexible copper tapes; their deformation compensates for the differential shrinkage of the link components and possible curvature of the link profile.

Liquid nitrogen flows inside and outside the tubes and tapes, in the channel defined by the pipe wrapped with a super-insulation, advantageously a mylar sheet coated with an aluminum, in order to avoid induced currents. An insulating link prevents the current from flowing in the pipe. A vacuum gap closed by a second pipe is used for electrical and for thermal insulation.

The cold-dielectric approach makes it possible to house all three phases equilaterally inside a single cryostat without causing large degradation and AC losses due to the fields generated by the neighboring phases. This also lowers the thermal loss through separate cryostats.

A further optimization is realized by making the three phases concentric to each other. No shielding layer is required in such a tri-axial configuration. It is more compact and require only about half of the HTS tapes as that of three separately shielded phases. Another advantage is that the cold-dielectrics stays cold. Thus, it does not suffer from degradation due to temperature rise from the heat loss as would be the case for a conventional tri-axial cable.

### EXAMPLE

A 1.5-m long tri-axial HTS cable was fabricated for evaluation of its superconducting properties with DC and AC currents. FIG. A shows a sketch of the end of the tri-axial cable. A stainless steel former was used to wind the cable on. Each phase consists of two layers of BSCCO-2223 HTS tapes. They are separated by Cryoflex™ cold dielectric tapes. A layer of Cu-tape was also added at the OD of the triax as a shielding ground. The cable was rated for 1250 A-rms per phase.

For the electrical testing of the cable, voltage taps were added on each of the three phases. One of the voltage leads was pulled to the other end of the cable to join with the other lead before the dielectric and the next HTS phase were wound on. The actual voltage lead length is 1.54 m, 1.24 m, and 0.91 m for phases 1 to 3, respectively. The G-10 insert shown in FIG. A was added for the purpose of a calorimetric measurement of the AC losses of the cable. Two type-E thermocouples were attached on the G-10 rod. When the rod was inserted inside the former, the thermocouples touched the former at the mid-point and at quarter way from an end. The G-10 insert was sealed with silicon grease so that no liquid nitrogen can get inside the former.

[image]

DC V-I Characteristics

The DC test of the tri-axial cable was performed with a 25-kA, 15-V DC power supply. FIG. B shows the measured V-I curves of each of the three HTS phases. At the standard 1 μV/cm criteria the critical current was found to be 3.6 kA, 3.1 kA, and 2.8 kA for phases 1 to 3, respectively. Note that these values are comparable to cables which used four layers of HTS tapes for each phase conductor.

The electrical tests of this cable were performed over a 5 months period. Numerous cooldown and warmup cycles with liquid nitrogen and changing of bulky power lead connections were required. The latter caused clearly visible damage to a lead connector of phase 1. Similar damage may also have occurred in phase 2. These two phases showed some degradation in the V-I curves. On the other hand, the V-I curve of phase 3 remained the same throughout the whole test period. There was no degradation in this phase.

Calorimetrics

A calorimetric technique was developed to measure the AC loss of HTS cables. To measure AC loss, the cable was inserted inside a G-10 tube filled with wax to create a radial thermal barrier between the HTS conductor and the liquid nitrogen bath. The temperature rise of the HTS cable due to the AC loss was measured with thermocouples attached to the conductor and referenced to the bath. The present tri-axial cable was built with three dielectric layers. This provides some thermal barrier. The AC loss induced temperature rise on the former was measured with thermocouples attached on a G-10 rod and inserted inside the former as shown in FIG. A.

Heat Load Calibration

The DC characteristics of the HTS phase conductors were used to calibrate the temperature rise for a known heating power. A DC current close to and higher than the critical current of the HTS conductor was applied to the phase conductor. The voltage drop

[image]

and current of the cable were measured to calculate the power input. The temperature rise on the former at this input power was measured by the thermocouples. FIG. C shows an example of this heat load calibration. A DC current of 3.2 kA was applied to the phase-1 HTS conductor. This developed a constant voltage of 0.54 mV across the cable. The thermocouple showed a gradual temperature rise and reached a flat top of about 0.05 K in 100 s. After the current was turned off, it also took about 100 s for the former to cool back down to the bath temperature. By varying the current, a set of ΔT versus the heating power per unit length, p was obtained. The oscillation in the temperature rise curve indicated a sensitivity of about 0.01 K for the instrumentation used in the present test. This limits the present calibration and the calorimetric data of the outer two phases of the tri-axial cable. To clarify the situation a finite element thermal model calculation was performed.

Finite Element Thermal Modeling

A finite element thermal model of a small section of the HTS tri-axial cable was built using SINDA Thermal Desktop™ comprised mainly of eight-node solid elements. The nodes on the outermost surface of the copper shield layer had a fixed LN₂-temperature boundary condition applied to them. All other external surfaces were considered adiabatic. The HTS phase conductor layers were modeled as a single element thick and had heat generation applied to them as appropriate to simulate the calibration or ac loss heat load.

The thermal properties of many of the materials used in the test article, such as G-10, stainless steel, and copper, are well characterized in literature. The HTS tapes were assumed to behave thermally as silver. For the Cryoflex™ tape dielectric material, low temperature thermal conductivity data was not found. The effective thermal conductivity used to model the Cryoflex™ layers was adjusted by using the temperature rise data obtained from the DC calibration tests of phase 1. This innermost phase calibration data had the highest temperature rise, and would be the most accurate measurement to use to estimate the thermal conductivity. Once this value was determined, calculations were made to determine the temperature rise for heating in the other two HTS phases. FIG. D shows the temperature profile across the radial section of the tri-axial cable for a heat load of 1 W/m applied to phase 1. A constant temperature rise of, ΔT₁=0.052 K was found inside the former of the cable.

[image]

[image]

[image]

Similar results were obtained for heat load on the other two phases. The calculations show that there is less temperature rise as the heating is applied to layers farther away from the center of the HTS cable. This is because there is less thermal resistance to the liquid nitrogen as the distance from the heat source to the liquid nitrogen decreases. For the heat load of 1 W/m the temperature rise in phase 2, ΔT₂ was found to be 0.029 K, and in phase 3, ΔT₃ was 0.010 K. The temperature rise was further found to be linear with respect to the heat load. This is shown in FIG. E, together with the calibration data of phase 1. Also shown in the figure is the temperature rises when the same heat load is applied simultaneously in all three phases, ΔTₜᵣᵢ. These temperature rise versus heat load curves are used to calculate the calorimetric AC losses.

These results also indicate that the temperature rise on the HTS phases would be minimal, if one chooses to cool the tri-axial cable on the perimeter alone, ie. no coolant flow through the former. For an AC loss of 3 W/m (1 W/m per phase), the highest temperature rise in the cable is still less than 0.1 K No degradation in the HTS phase conductors would be expected.

[image]

[image]

[image]

FIG. E. Temperature rise inside the former as a function of heat load applied separately on each phase and simultaneous on all 3 phases.

AC Loss Measurements

AC loss of the tri-axial HTS cable prototype was first measured with the existing single-phase AC power supply. Both electrical and calorimetric techniques were used in the measurement. The power supply was then upgraded to three phases. They were powered by a single 480-V source. Thus, the phase angles were fixed at 120° apart. Separate Variacs permitted individual control of the phase currents.

Single-Phase Measurements

AC loss was measured up to 1350 A on each of the three phases separately. For the electrical measurement, the voltage and the phase angle, θ relative to the current were measured with a lock-in amplifier. The per unit length AC loss was then calculated by p=VI cos θ/L, where L is the voltage taps length of each of the phases. For the calorimetric measurement, the equations shown in FIG. E were used to determine the individual phase AC losses. FIG. F shows the results on phase 1 of both of the measurements. Because of the sensitivity limit mentioned before, the calorimetric data range was limited. But the two sets of data agree with each other surprisingly well. This provides further confidence to the calibration procedure discussed earlier.

Also shown in FIG. F is a curve calculated with the monoblock theory. It is seen that the experimental AC loss data is in fair agreement with this simple theory. Similar results were observed for the AC losses measured electrically for phases 2 and 3. Note that at the design current of 1250 A-rms, the AC loss on phase 1 was measured to be 0.35 W/m. For the same loss on phase 2 and 3, FIG. 5 indicated that the temperature rise on phase 2 would be 0.01 K and on phase 3 would be 0.004 K Both are at or below the sensitivity of the temperature instrumentation. No measurable calorimetric AC loss data was obtained on these two outer phases.

Three-Phase Measurements

When more than one phase of the tri-axial cable had current applied, the mutual inductance among the phases affects the phase angle between the current and the voltage of each individual phase. This interaction precluded a definitive loss voltage measurement on

[image]

[image]

[image]

each phase from the lock-in amplifier measurement. This was anticipated from the outset and the calorimetric technique alone was used, although its useful range was limited.

The AC loss of the tri-axial cable was measured calorimetrically with equal currents of up to 1350 A on all three phases. To double-check the effect of neighboring phases, we also ran a series of adding current to successive phases. First, the current was brought up on phase 1 only. After the temperature rise was stabilized, the same amount of current was brought up on phase 2 to measure the additional temperature rise. Then the phase 3 current was brought on to measure further temperature rise. FIG. G shows an example of such a sequential multi-phase AC loss measurement. With a current of 1300 A on phase 1 alone, a temperature rise of about 0.024 K was observed. When the same amount of current was also brought on phase 2, there was only a small additional temperature rise. After the current was also brought on phase 3, the total temperature rise was about 0.030 K. The temperature rise on the cable appears to be even more dominated by phase 1 than that indicated in FIG. E from the model calculation.

If the currents on phases 2 and 3 introduced significant additional AC loss on phase 1, one should see more temperature rise above 0.024 K. If the AC losses on phase 2 and 3 were more than the loss of its own current, the additional temperature rise should be much more than that shown in FIG. G. Neither of these effects was seen. Thus, this and all other multi-phase AC loss measurements showed that there is no measurable excess AC loss. The AC loss of the tri-axial cable can be approximated by using the ΔTₜᵣᵢ calibration equation in FIG. E that assumed equal loss in each of the three phases. The result is shown in FIG. H. It is seen that the calorimetrically measured AC loss of the tri-axial cable is also in fair agreement with the sum of the three individual phase loss calculated by the monoblock theory. This is a further indication that there is no excess AC loss in tri-axial configuration where the three phases are concentric to each other. At the design current of 1250 A, the measured total AC loss of the present tri-axial cable is only about 1 W/m.

[image]

FIG. H. Total tri-axial cable AC loss as compared to the monoblock theory calculation that sums the three individual phase losses with no additional terms.

Individual phase AC losses show good agreement with the monoblock theory. The 3-phase calorimetric AC loss data is close to that of the sum of three individual phases. There is no measurable excess AC loss due to the presence of the other concentric phases in tri-axial cable configuration. At the design current of 1250 A, the measured total AC loss of the present tri-axial cable prototype was only about 1 W/m.

What is claimed is:

1. A superconducting cable (10) for alternating current with phase and shield conductors (22, 23, 24, 16), cooling channels (11, 17) and-an outer-boundary vacuum-insulation (19), whereby for all three phase conductors (22, 23, 24) a common shield (16) is provided, and the conductors (22, 23, 24, 16) and the cooling channels (11, 17) are arranged concentrically.

2. The superconducting cable according to claim 1, wherein the first phase conductor (22) adjacent the cooling channel (11) is bounded by the former and an insulation layer of defined thickness is provided between the first and second phase conductors (22, 23), the second and the third phase conductors (23, 24) as well as the third phase conductor (24) and the neutral conductor, respectively, and a cooling channel (17) is provided as an annular channel between the neutral conductor (16) and the vacuum-super-insulation (19) and the phase conductors (22, 23, 24) are manufactured of a superconducting material.

3. The superconducting cable according to claim 1 wherein each phase conductor (22, 23, 24) is manufactured of superconducting tapes consisting of flat rolled sleeves, wrought of an oxygen-porous metal filled with a ceramic superconducting material.

4. The superconducting cable according to claim 3 wherein the superconducting material is selected from the group consisting of Bi-2223, Bi-2212, and YBCO coated conductor.

5. The superconducting cable according to claim 1 wherein the phase conductors (22, 23, 24) are manufactured as tapes that are wrought of silver sleeves and filled with a superconductor material containing at least bismuth and copper.

6. The superconducting cable according to claim 5 wherein the superconductor material is Bi-2223.

7. The superconducting cable according to claim 1 wherein liquid nitrogen is conducted through the channels (11 and 17) for the cooling of the superconducting phases (22, 23, 24).

8. The superconducting cable according to claim 1 wherein the neutral conductor is manufactured of copper.

9. The superconducting cable according to claim 1 wherein the insulation layers (13, 14, 15) between the phase conductors (22, 23, 24) are manufactured of polyethylene or polypropylene.

10. The superconducting cable according to claim 1 wherein the vacuum-super-insulation (19) is manufactured of aluminum-evaporated plastic film.
